(19) United States
(12) Patent Application Publication
(10) Pub. No.: US 2020/0086438 A1
(43) Pub. Date: Mar. 19, 2020

(54) SPINDLE ALIGNMENT AND MACHINE TOOL

(71) Applicant: CHIRON-WERKE GmbH & Co. KG, Tuttlingen (DE)

(72) Inventors: Alwin MATTES, Spaichingen (DE); Frank MAZZEO, Denkingen (DE); Sebastian GLOECKLER, Leibergingen-Thalheim (DE); Patrick SCHREYECK, Nusplingen (DE)

(21) Appl. No.: 16/567,545

(22) Filed: Sep. 11, 2019

(30) Foreign Application Priority Data
Sep. 17, 2018 (DE) 10 2018 122 765.5

(51) Int. Cl. B23Q 3/18

(52) U.S. Cl. CPC B23Q 3/186

(57) ABSTRACT

There is provided a method for aligning a spindle of a machine tool, the spindle having a longitudinal axis and being rotatable about the longitudinal axis. A trial mounting of the spindle is performed, comprising mediately or directly attaching a bearing surface of the spindle to a support surface of the spindle housing. An actual deviation of the spindle is detected. A wedge-shaped adjustment disc is selected, depending on the detected actual deviation. The adjustment disc is arranged between the bearing surface of the spindle and the support surface of the spindle housing in a defined rotation orientation so that the adjustment disc at least partially corrects the actual deviation.

### CROSS-REFERENCES TO RELATED APPLICATIONS

This application claims priority to German patent application 10 2018 122 765.5, filed on Sep. 17, 2018. The entire content of that priority application is fully incorporated by reference herewith.

### BACKGROUND

The present disclosure relates to a method for aligning a spindle of a machine tool, such as a motor spindle or a spindle that is coupled to a motor. In certain embodiments, the present disclosure relates to a method for aligning a tool spindle. In certain embodiments, the present disclosure relates to a method for aligning tool spindles of a double spindle arrangement of a machine tool. In certain embodiments, the present disclosure relates to a use of a set of adjustment discs for aligning a motor spindle. In certain embodiments, the present disclosure relates to a corresponding machine tool. In certain embodiments, the present disclosure relates to a machine tool having a double-spindle arrangement.

A machine tool with a double spindle arrangement is known from WO 00/37213 A2. Piezo actuators are provided for position correction for the spindles of the double spindle. In this way, an automatic and adaptive alignment of the spindles should be enabled. However, it has been observed that such approaches pose a number of challenges in practical implementation, for instance in regard of stiffness. This has, in turn, a negative effect on the accuracy to be achieved.

The alignment of spindles, such as motor spindles or spindles with motor, for instance machining spindles (also referred to as main spindles), is of huge importance for the accuracy that can be achieved with the machine tool. The perpendicularity between the spindle and the clamping surface for the workpiece is often an important parameter for accuracy. This applies all the more in the case of arrangements in which two spindles having a motor, such as two tool spindles, are arranged side by side. Such an arrangement is also referred to as double spindle arrangement. The two spindles can be arranged in a common housing or in separate housings.

Double spindle arrangements can be used to increase productivity by machining two workpieces in parallel. However, double spindle arrangements are also used to perform different machining operations on a workpiece, for example with different tools. For many applications, it must be ensured that the two spindles are aligned parallel to each other. In regard of parallelism, only minimum deviations are tolerable.

Even with arrangements with only one tool spindle, there are high accuracy requirements for the alignment of the tool spindle in relation to a workpiece support, for example in relation to a table or a cradle. It is often a matter of aligning the spindle as perpendicular as possible with respect to a workpiece table or a cradle (at least in its neutral position).

Tool spindles are regularly arranged as motor spindles. The spindles, for example, are arranged like cartridges and regularly comprise integrated drives. The spindles can be mounted on a spindle housing. The spindle housing can basically be an immovable/fixed spindle housing. However, spindle housings are regularly mounted on movable slides or directly on guides so that the spindle and a tool mounted thereon can be moved relative to the workpiece. In such a case, an exact alignment of the contact surfaces/joining surfaces of spindle and spindle housing is crucial. However, it is also conceivable to use spindles that do not have an integrated motor (rotor shaft provided with tool holder), but are otherwise coupled or coupleable to a motor. Such spindles may be referred to as spindles comprising a motor.

For example, a spindle has an axial bearing surface and a cylinder fitting surface, which are used for assembling. On the spindle housing, for example, a counter surface (support surface) is provided. The spindles and/or spindle bodies are attached directly or mediately (via intermediate elements) to the spindle housing. For example, a so-called mounting plate (also referred to as motor plate) is provided, which is interposed between the spindle and the spindle housing.

The contact surfaces involved in the assembly of the spindles must be manufactured with high precision. Nevertheless, in practice (small) deviations in position and/or shape can be present due to manufacturing and assembly, which can eventually lead to an incorrect alignment of the spindles. This often involves inclination errors (tilting errors) of the spindles.

It is therefore regularly necessary to align the spindle precisely during assembly. This often involves time-consuming manual activities. For example, manual alignment involves mounting a measuring mandrel in the tool holder and checking the longitudinal axis of the motor spindle parallel to the travel axis of the spindle housing (for example in the Z direction) using suitable measuring equipment that engages the measuring mandrel. The reference of the measuring equipment can be, for example, the workpiece support. In this way a tilting error of the spindle can be determined.

An option for compensation is to (minimally) machine contact surfaces on the spindle housing depending on the determined tilting error, e.g. by scraping. This is a time-consuming iterative process which sets high demands regarding the qualification and experience of the workers.

In view of this, it is an object of the present disclosure to present a method for the alignment of a spindle of a machine tool which enables the spindle to be aligned quickly, but also with high precision.

It is a further object of the present disclosure to present practical approaches to the alignment of spindles, e.g., of their longitudinal axes, relative to their installation environment in machine tools.

It is a further object of the present disclosure to present a method which allows spindle alignment with reduced or even without additional reworking/finishing on the spindle and/or spindle housing for alignment purposes.

It is a further object of the present disclosure to present an alignment method which is reproducible and which does not require broad and extensive experience.

It is a further object of the present disclosure to present an alignment method which reduces the number of iteration steps or even makes additional iteration steps superfluous.

It is a further object of the present disclosure to present an alignment method which is suitable for aligning two spindles of a double spindle arrangement.

It is a further object of the present disclosure to present a machine tool having at least one tool spindle that is adjusted with high-precision.

### SUMMARY

In regard of the method, these and other objects are achieved by a method for aligning a spindle of a machine tool, the method comprising the following steps:
performing a trial mounting of the spindle at a spindle housing, comprising direct or indirect attachment of a bearing surface of the spindle to a support surface of the spindle housing,
detecting an actual deviation of the spindle, for instance an actual tilting (tilt error) of a longitudinal axis of the spindle,
selecting an adjustment disc depending on the detected actual deviation, wherein the adjustment disc is wedge-shaped, and
arranging the adjustment disc between the bearing surface of the spindle and the support surface of the spindle housing in a rotation orientation which at least partially corrects the actual deviation.

In regard of the machine tool, these and other are achieved by a machine tool, comprising:
a workpiece support for holding at least one workpiece, and
a spindle housing supporting at least one tool spindle, which is arranged as a spindle for holding at least one tool which can be driven about its longitudinal axis,

wherein relative movements can be generated between the workpiece support and the at least one tool spindle, and

wherein the tool spindle is coupled via an adjustment disc to a support surface of the spindle housing, the adjustment disc being wedge-shaped and being arranged in a rotation orientation between the bearing surface of the tool spindle and the support surface of the spindle housing so that a deviation of the tool spindle with respect to the workpiece receiving is at least partially compensated.

In certain exemplary embodiments, the adjustment discs allow a high-precision alignment and arrangement of the spindle without manual reworking at the seat of the spindle at/in the spindle housing. This may significantly reduce the effort required for aligning the spindle. High-precision alignment can nevertheless be achieved by selecting a suitable adjustment disc, at least in certain embodiments. In certain exemplary embodiments, the adjustment disc is selected from a set which comprises a plurality of adjustment discs having different wedge thicknesses.

In certain embodiments, the rotation orientation of the adjustment disc is selected in such a way that the “error”, which is introduced by the adjustment disc due to the circular design, counteracts the actual deviation.

After the adjustment disc has been positioned between the bearing surface of the spindle and the support surface of the spindle housing, the spindle can be finally mounted and fixed. The term “between” is not to be understood so restrictive as to require that the adjustment disc is exactly and directly between the bearing surface of the spindle and the support surface of the spindle housing. The term “between” is not to be understood strictly structurally but functionally. In certain exemplary embodiments, a single adjustment disc is sufficient to align the spindle. In certain exemplary embodiments, the goal of the adjustment is the perpendicularity of the spindle with reference to a workpiece support or workpiece holder, at least in a neutral position of the workpiece support. In the alternative, or in addition, the goal of the adjustment may be a parallelism between the spindle and a reference. The reference may be an axis in the coordinate system of the machine and/or a spindle axis of another spindle (in the case of a double spindle arrangement).

The adjustment disc is wedge-shaped. The adjustment disc comprises frontal faces facing away from each other, which are not parallel to each other. In other words, the wedge shape is present in a side view and/or a sectional view through the adjustment disc. In other words, the adjustment disc is not necessarily eccentric. Rather, for example, there are frontal faces which are minimally inclined with respect to one another in the longitudinal direction (of the spindle), which cause a tilting between the spindle and the spindle housing that counteracts the actual deviation. Other designs are conceivable.

The actual tilting can be determined in relation to a workpiece support (workpiece holder, clamping surface, etc.). In other words, the actual deviation can describe a deviation (of the position and orientation of the spindle axis) from the desired ideal perpendicularity between the spindle and the clamping surface. Furthermore, the actual deviation can also describe a parallelism error (tilt error) between two spindles. The actual tilting can also be determined with respect to a traverse axis of a relative movement between the spindle housing and the workpiece support (for instance in the Z direction).

Generally, the adjustment disc has only a minimal wedge shape. Generally, this involves deviations of less than 100 μm (micrometers), for example in relation to an outer diameter of the adjustment disc being in the range between 200 mm and 300 mm (millimeters). In certain embodiments, the wedge thickness is the difference between two opposite wall thicknesses of the adjustment disc, one of which being a minimum thickness, the other one being the maximum thickness. The ratio between the wedge thickness and the diameter of the adjustment disc corresponds to a wedge angle. Based on this wedge angle, wedge thicknesses for other diameters can be determined. The wedge angles are merely very small. The adjustment discs can be manufactured with high precision using suitable fine machining or micro-finishing processes. The adjustment disc introduces a deliberate error into the system, which at least partially compensates for the actual deviation.

The spindle housing can also be referred to as the headstock. The spindle housing forms an outer housing in which, for example, a cartridge-like spindle can be accommodated. The spindle itself has a spindle body with a housing. Accordingly, drives, bearings, output shafts, tool holders, etc. can be arranged in the spindle body of the spindles.

The actual deviation may be caused by manufacturing tolerances and/or assembly tolerances. Corresponding errors can occur both on the spindle housing and on the spindle itself.

The spindle can, for example, be mounted mediately on the spindle housing via a so-called motor plate/mounting plate. A direct mounting is also conceivable.

The adjustment disc comprises frontal faces which are (minimally) inclined towards with respect to one another. Macroscopically seen, the frontal faces can be almost parallel. Nevertheless, the adjustment discs have a minimal wedge shape. The direction of the wedge is indicated, for example, by an indicator element. The adjustment disc can be arranged as a (thin) ring, which is located between the spindle housing and the motor plate.

The longitudinal axis of the spindle is ideally parallel to a Z axis (e.g. a travel axis extending along a Z direction), when there is no tilting error. Therefore, the goal of alignment is to align the spindle as perpendicular as possible to a plane that is defined by an X axis and a Y axis.

The actual deviation (of the longitudinal axis of the spindle) can be determined, for example, by using a dial gauge or the like that is coupled with a measuring mandrel that is picked up at the spindle. The dial gauge is coupled in a suitable manner with a reference element (workpiece clamping surface, adjacent spindle, etc.).

By way of example, the dial gauge can be arranged and aligned in such a way that deviations in the Y-direction can be detected. The deviations in the Y direction can be detected by generating a Z movement between the spindle and a workpiece support. The dial gauge therefore determines deviations in the Y direction during this relative movement (in Z).

Furthermore, the dial gauge can be arranged and aligned in such a way that deviations in the X-direction can be detected. The deviations in the X direction can be detected by generating a Z movement between the spindle and a workpiece support. The dial gauge therefore determines deviations in the X direction during this relative movement (in Z).

From the deviations in the Y-direction and the deviations in the X-direction eventually a vector can be derived which describes the tilting. Due to their slight wedge shape, the adjustment discs have defined deviations which, depending on the rotation position of the adjustment discs, at least partially compensate for the tilting of the spindle. The wedge shape also defines a vector of the “tilting” of the adjustment disc. The two vectors can be aligned to each other when mounting the adjustment disc, so that the compensation is as far-reaching as possible.

Therefore, an algorithm or a suitable set of tables is proposed, based on which the selection of the adjustment discs as well as their rotation orientation shall be simplified. The goal of the selection is often a minimum residual deviation after mounting the adjustment disc. A complete elimination of the error is regularly not possible and also not necessary. Residual errors are caused, for example, by the limited number of rotation positions of the adjustment disc and/or by the gradation of the “wedge thicknesses”.

In accordance with an exemplary embodiment, the method also comprises the following steps:
providing a set with a plurality of adjustment discs with different wedge thicknesses, and
selecting the adjustment disc whose wedge thickness corresponds at least approximately to the detected actual deviation as the adjustment disc for the correction.

In accordance with an exemplary embodiment, the method also comprises the following steps:
providing a set with a plurality of adjustment discs with different wedge thicknesses, and
selecting two or more adjustment discs of the set whose combined wedge thickness at least approximately corresponds to the detected actual deviation as the adjustment disc for the correction.

In this way, by providing a manageable number of adjustment discs with different wedge thicknesses for a considerable range of possible deviations, a suitable adjustment disc can be provided to correct the orientation of the spindle. It goes without saying that in cases of major deviations, it is in principle also possible to use a plurality of adjustment discs, the wedge design of which is added up.

According to another exemplary embodiment, the method also includes the provision of a set of at least three adjustment discs with different wedge thicknesses. It goes without saying that also sets with four, five or even more adjustment discs with different wedge thicknesses are conceivable. If a machine tool with double spindle arrangement is involved, also a double number of adjustment discs of the respective types can be provided. The adjustment discs of the set can be adapted to the expected manufacturing tolerances/assembly tolerances. It is possible to combine two or more of the adjustment discs to match a certain actual deviation as closely as possible.

In certain embodiments, a set of tables or an algorithm implemented in software is provided, based on which the respective adjustment disc including the suggested rotation orientation can be easily selected from the set of adjustment discs. The input variable for the selection is the previously determined actual deviation. The actual deviation represents, so to say, the actual vector and/or the actual tilting of the longitudinal axis of the spindle. It goes without saying that the actual deviation can also be described by ΔX (Delta X) and ΔY (Delta Y) values, which describe deviations of a defined point (with defined Z-position) of the longitudinal axis from an imaginary ideal longitudinal axis. The actual vector can also be described in this way.

According to another exemplary embodiment of the method, the wedge thicknesses of the adjustment discs of the set are graduated with respect to each other by a value of about 5 μm to 20 μm, in relation to an outer diameter of the adjustment discs. The increment is therefore 5 μm to 20 μm. In this way there are fine gradations between the adjustment discs.

In this way, slight residual deviations may be compensated. The wedge thickness is the difference in the height (thickness) of the disc at two opposite ends of the disc, one of which having the minimum thickness and the other the maximum thickness. A usual outer diameter of the adjustment discs, for example, is about 200-300 mm, for instance about 250 mm.

There is only a small increment between two successive adjustment discs of a set. This enables a high degree of accuracy, since the gradation-related error can be minimized.

According to another exemplary embodiment of the method, the wedge thickness of an adjustment disc, in relation to an outer diameter of the adjustment discs, is in a range between 5 μm and 100 μm compared to a plane-parallel disc. In this way, on the one hand, considerable deviations can be compensated and, on the other hand, relatively small deviations can be further reduced.

According to the above definition, a plane-parallel disc has a wedge thickness of 0 μm. However, as soon as the frontal faces of the adjustment disc facing away from each other are slightly inclined with respect to each other, the wedge thickness is greater than 0 μm. In certain embodiments, one of the two frontal faces is aligned exactly perpendicular to the center axis by the adjustment disc. Accordingly, the other face is slightly tilted and/or inclined in relation thereto.

According to another exemplary embodiment, a number of defined rotation positions is provided for the adjustment disc between the bearing surface of the spindle and the support surface of the spindle housing. This may involve a corresponding number of recesses (through holes) for fastening elements. As an example, a rotation increment of 30° (degrees) or 15° is provided. This corresponds to 12 or 24 recesses. Hence, in certain embodiments, a plurality of indexed rotation positions is provided.

Similar to a clock, it can then be specified in which rotation orientation the adjustment disc is to be mounted. The orientation and position securing of the rotation position can be achieved via pins, screws, bolts and corresponding counter elements.

The algorithm and/or the table therefore leads to a recommendation for an adjustment disc of a certain wedge thickness for a given actual deviation, which must be installed in a certain rotation position (e.g. “9:00 o'clock position”). This greatly simplifies the alignment and adjustment procedure. The goal of the optimization task is to have a residual error that is as small as possible after mounting the adjustment disc.

According to another exemplary embodiment of the method, the wedge disc is mounted in such a way that the error caused by the wedge shape of the adjustment disc counteracts the actual deviation of the spindle. In certain embodiments, this applies at least for the increments that are caused by the gradation of the wedge thicknesses and the defined number of rotation positions (angular position).

According to another exemplary embodiment of the method, the detection of the actual deviation comprises, at least approximately, a detection of a deviation of a reference point in two spatial directions in a plane which is oriented perpendicular to the longitudinal axis of the spindle and which is at a distance from the bearing surface of the spindle and the support surface of the spindle housing. In this way the “vector” of the deviation can be determined. The deviations in X and Y can be determined by means of a dial gauge or similar measuring equipment that engages a measuring mandrel or a similar element while the same is being moved in a defined manner by the spindle. When the Z position of the reference point is fixed or even predefined, the actual deviation can be determined on the basis of only two values (ΔX and ΔY), wherein as a result the adjustment disc to be selected and its mounting position can be output/read.

According to another exemplary embodiment of the method, the detection of the actual deviation comprises the detection of an actual angular deviation and an actual rotation position of the actual angular deviation of the spindle. The actual deviation (inclination error) may also be determined in this way. In accordance with this approach, the actual vector (tilting of the longitudinal axis of the spindle) is measured directly. The information on the actual deviation therefore includes an angle (tilt angle relative to an ideal orientation of the longitudinal axis) and a rotation position (“clock hand”) in which the tilt is clearly present.

According to another exemplary embodiment of the method, the spindle is attached to the spindle housing via a mounting plate, wherein the mounting plate is connected to the support surface of the spindle housing and to the bearing surface of the spindle. Accordingly, the spindle is not directly connected to the spindle housing via its spindle body but mediately via a (possibly separate) mounting plate.

In accordance with another exemplary embodiment of the method, a suitable tuning ring is selected for the adaptation/alignment of the position in the Z direction depending on a measured Z deviation, wherein the tuning ring is interposed between the spindle and the spindle housing. Accordingly, the spindle is mounted, by way of example, using both the adjustment disc and the tuning ring. The adjustment disc compensates for the tilting error of the longitudinal axis. The tuning ring compensates for possible deviations in the Z direction. The adjustment ring is therefore arranged plane-parallel.

In accordance with an exemplary embodiment, the spindle is coupled to the spindle housing via the adjustment disc, the mounting plate and the tuning ring.

According to an exemplary embodiment, the spindle is mounted in such a way that the tuning ring and the adjustment disc are arranged concentrically (one inside the other), wherein both the tuning ring and the adjustment disc are connected to the frontal face of the mounting plate, wherein the tuning ring contacts the bearing surface of the spindle with its opposite frontal face, and wherein the adjustment disc contacts the support surface of the spindle housing with its opposite frontal face. Accordingly, the connection between the spindle housing and the spindle is achieved via the adjustment disc, the mounting plate and the tuning ring. In accordance with this embodiment, the tuning ring is arranged inside the adjustment disc. However, it is also conceivable to have it the other way round. Accordingly, the inner ring may have a wedge shape and the outer ring may be plane-parallel.

According to another exemplary embodiment, the tuning ring and the adjustment disc form an axial package. However, it is also conceivable to compensate both tilting errors and position errors in the Z-direction via the adjustment disc. Accordingly, the tuning ring and adjustment disc would be combined into one part.

According to another exemplary embodiment, the spindle is alternatively or additionally adjusted in a plane perpendicular to its longitudinal axis by at least one adjusting element. Accordingly, the X-position and/or the Y-position can be adjusted. The adjusting element can be an eccentric or the like. Usually, only short strokes/travels are required to achieve the desired alignment. As an example, such an adjusting element is arranged circumferentially, e.g. on/near the mounting plate. Accordingly, a bearing element (such as a pin or the like) is provided on an opposite circumferential portion. A movement of the adjusting element (e.g. the eccentric) therefore causes a slight swiveling of the spindle around the bearing element. In this way, minimal adjustments can be made to the X position and/or the Y position.

Especially for an arrangement having a double spindle, it is conceivable that one of the two spindles is equipped with an adjusting element for adjustments in the X direction and the other one of the two spindles with an adjusting element for adjustments in the Y direction. Accordingly, the adjusting elements on their respective spindles are arranged at a circumferential offset of about 90° with respect to each other, compared to the other spindle. The adjustment option in the X-direction and/or the Y-direction allows an exact positioning of the longitudinal axes of the two spindles. Overall, the parallelism of a double spindle can be optimized on the one hand, but also the Z-alignment and the alignment in the X-direction as well as the Y-direction of both spindles on the other.

In accordance with another aspect, the present disclosure relates to a method for aligning a double spindle of a machine tool comprising a first spindle and a second spindle that are arranged in a common spindle housing, the method comprising the following steps:
aligning the first spindle in accordance with the method according to one of the embodiments described herein, the alignment being performed with respect to a workpiece support or a traversing axis, and
aligning the second spindle in accordance with the method according to one of the embodiments described herein, the alignment being performed relative to the first spindle in order to obtain a desired parallelism between the two spindles.

In this way, two spindles arranged next to each other can be aligned with high precision. According to another exemplary embodiment, the method also includes a step of alignment in the Z-direction. According to another exemplary embodiment, the method also includes a step of alignment in the Z-direction and the X-direction and/or the Y-direction.

According to another exemplary embodiment, the method also includes the following step:
aligning the first spindle and the second spindle in a plane perpendicular to the spindle axis,

wherein a first adjusting element, for instance a first eccentric, is associated with the first spindle and the spindle housing,

wherein a second adjusting element, for instance a second eccentric, is associated with the second spindle and the spindle housing,

wherein the first adjusting element is adapted to displace the first spindle relative to the spindle housing in a first direction,

wherein the second adjusting element is adapted to displace the second spindle relative to the spindle housing in a second direction; and

wherein the first direction and the second direction are oriented inclined to each other, for instance perpendicular to each other.

In this way, positioning can be performed in a plane parallel to the X axis and to the Y axis. Thus, a desired relative position and/or relative orientation may be set between the two spindles.

Furthermore, the present disclosure relates to a machine tool, for instance a multi-axis milling machine, comprising the following:
a workpiece support for holding at least one workpiece, and
a spindle housing supporting at least one tool spindle, which is arranged as a spindle for holding at least one tool which can be driven about its longitudinal axis,

wherein relative movements can be generated between the workpiece support and the at least one tool spindle, and

wherein the tool spindle is coupled via an adjustment disc to a support surface of the spindle housing, the adjustment disc being wedge-shaped and being arranged in a rotation orientation between the bearing surface of the tool spindle and the support surface of the spindle housing, so that a deviation of the tool spindle, for instance an actual tilting of a longitudinal axis of the spindle, with respect to the workpiece receiving is at least partially compensated.

According to an exemplary embodiment, the machine tool comprises a first spindle and a second spindle, which are mounted on a common spindle housing and aligned parallel to each other, wherein at least the first spindle or the second spindle is coupled to a mounting surface of the spindle housing via an adjustment disc.

Such a double spindle arrangement is suitable for parallel machining of two workpieces. It can also be used to perform different machining operations that require different parameters (rotational speed, etc.) and/or different tools.

Furthermore, the present disclosure relates to a use of a set of adjustment discs for aligning a spindle of a machine tool. In certain embodiments, the set of adjustment discs is used in at least one embodiment of the method according to the present disclosure.

It is to be understood that the previously mentioned features and the features mentioned in the following may not only be used in a certain combination, but also in other combinations or as isolated features without leaving the spirit and scope of the present disclosure.

### BRIEF DESCRIPTION OF THE DRAWINGS

Further features and advantages of the disclosure are disclosed by the following description of a plurality of exemplary embodiments, with reference to the drawings, wherein:

FIG. 1 is a perspective view of an exemplary embodiment of a machine tool, which is designed as a milling machine;

FIG. 2 is schematic partial view of an embodiment of a machine tool, comprising a spindle unit arranged as a double spindle and a cradle as a tool support;

FIG. 3 is a perspective partial view of a spindle unit of a machine tool in a partially exploded state;

FIG. 4 is an enlarged partial section view of the arrangement according to FIG. 3;

FIG. 5 is a simplified schematic sectional view of an embodiment of a spindle unit having a faulty spindle alignment;

FIG. 6 is a simplified frontal view of the spindle illustrated in FIG. 5;

FIG. 7 is a schematic cross-sectional view of a partially assembled spindle unit based on the embodiment illustrated in FIG. 5 to elucidate a set of adjustment discs;

FIG. 8 is a further schematic sectional view based on the embodiment illustrated in FIG. 5 to illustrate an aligned/adjusted state of the spindle;

FIG. 9 is a simplified frontal view of the spindle illustrated in FIG. 8;

FIG. 10 is a perspective partial sectional view of an embodiment of a spindle unit having a double spindle arrangement;

FIG. 11 is a schematic frontal view of a further embodiment of a spindle unit having a double spindle arrangement

FIG. 12 is a schematic block diagram illustrating an exemplary embodiment of a method for aligning a spindle; and

FIG. 13 is a schematic block diagram illustrating an exemplary embodiment of a method for aligning a double spindle of a machine tool.

### EMBODIMENTS

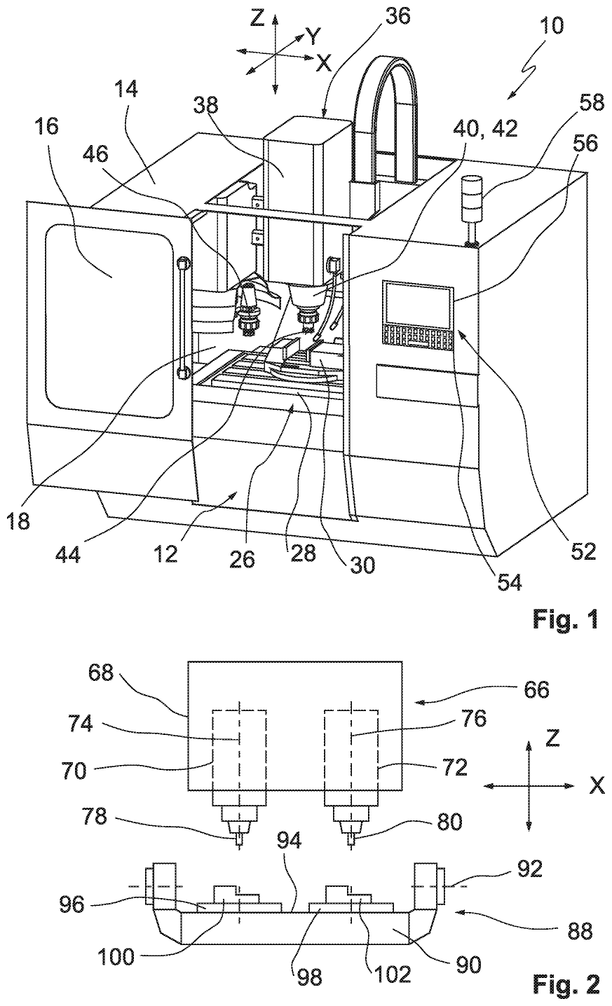

FIG. 1 illustrates, with reference to a perspective view, an exemplary embodiment of a machine tool that is designated in its entirety by 10. By way of example, the machine tool 10 is arranged as a milling machine or milling center. Generally, the machine tool 10 may be designed as a combined lathe/milling machine. The machine tool 10 is arranged for multi-axis machining.

The machine tool 10 is only shown as a representative of a large number of possible embodiments of machine tools.

The machine tool 10 comprises a frame 12, which may also be referred to as a bed or base. Furthermore, a housing designated by 14 is provided. Via a safety door 16, a process space 18 of the machine tool 10 can be made accessible. The machine tool 10 also includes a workpiece support 26, which may also be referred to as a workpiece table. The workpiece support 26 comprises, for example, a table 28. In the exemplary embodiment illustrated, the workpiece support 26 supports a workpiece holder 30, which may also be referred to as a fixture.

The machine tool 10 comprises a spindle unit 36. The spindle unit 36 comprises a spindle housing 38, which can also be referred to as a headstock. The spindle housing 38 carries a motor spindle 40, which is arranged as a workpiece spindle 42. The spindle may also be referred to as main spindle. A tool 44 is mounted to the workpiece spindle 42, for example a tool for milling operations. In addition, the machine tool 10 comprises, by way of example, at least one interchangeable tool 46 and corresponding equipment for changing the tools 44, 46. It goes without saying that the machine tool 10 may include additional handling devices for workpiece change, tool change, measuring tasks and the like. The motor spindle 40 may generally also be referred to as a spindle. Spindles within the meaning of the present disclosure involve at least motor spindles and spindles which can be coupled to a motor and which can be rotatingly driven.

Various design principles are known for machine tools. By way of example, the machine tool 10 may be arranged as a so-called travelling column machine. Furthermore, a portal design is also conceivable. A gantry design is also known. Further arrangements are conceivable.

The machine tool 10 merely exemplarily illustrated in FIG. 1 is arranged for and provided with suitable guides and drives to provide movement of the spindle unit 36 provided with the motor spindle 40 and of the tool 44 in at least three axes (spatial directions) X, Y, Z relative to a workpiece supported at the workpiece holder 30, confer the coordinate system X-Y-Z shown in FIG. 1. It goes without saying that further machining axes (for instance swivel axes) are also conceivable.

The machine tool 10 further comprises a control unit designated by 52. The control unit 52 includes controls 54 and a display 56, by way of example. Further, a signal unit designated by 58 is provided.

In certain embodiments, the present disclosure is concerned with the alignment of motor spindles and/or workpiece spindles in relation to the respective spindle housing of the spindle unit. A high-precision alignment is necessary for a good machining result, for instance for a high accuracy and dimensional accuracy of the machining operation.

This applies all the more to machine tools with so-called double spindle arrangements. FIG. 2 elucidates, with reference to a schematic representation, a spindle unit 66 that is arranged as a double spindle. The spindle unit 66 comprises a spindle housing 68, which can also be referred to as a headstock. The spindle housing 68 accommodates a first motor spindle 70 and a second motor spindle 72, each of which can be driven about its longitudinal axis 74, 76 to drive tools 78, 80.

In certain embodiments, the two motor spindles 70, 72 and/or their longitudinal axes 74, 76 are aligned parallel to each other. In other words, the goal is to achieve a state in which the longitudinal axes 74, 76 are arranged as precisely as possible parallel to the Z axis. Basically, the motor spindles 70, 72 should be aligned as perpendicular as possible with respect to the workpiece support 88. This applies at least to a neutral state (zero position) of the workpiece support 88.

In the embodiment illustrated in FIG. 2, the workpiece support 88 is arranged as a cradle 90. The cradle 90 has a (driven) swivel axis 92. The swivel axis 92 is parallel to the X axis, by way of example. The cradle 90 comprises a table 94 on which workpiece holders 96, 98 are arranged. For example, each of the workpiece holders 96, 98 supports a workpiece 100, 102, which can be machined by one of the two spindles 70, 72.

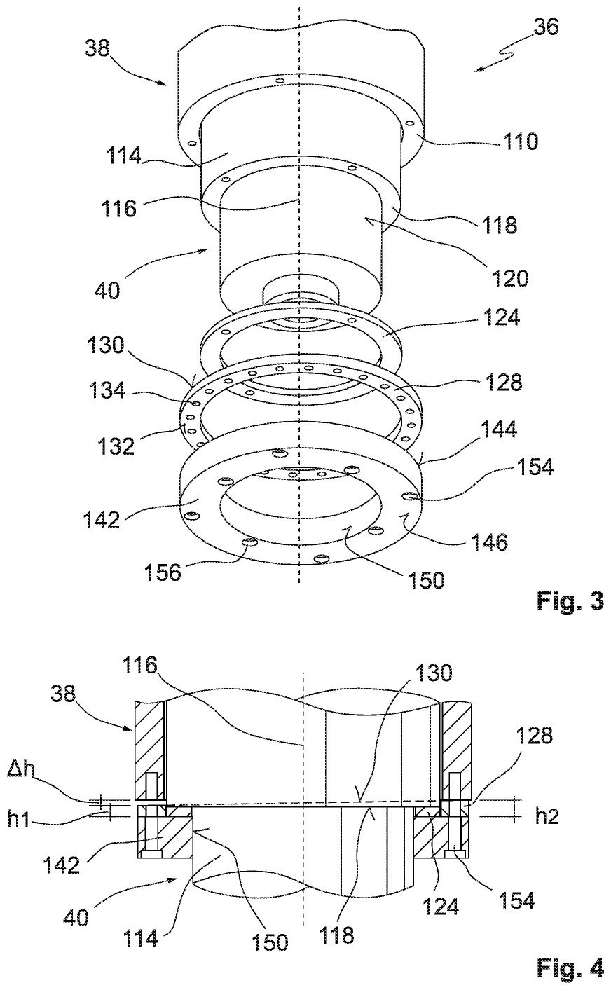

With reference to FIGS. 3-11, various approaches to high-precision positioning and alignment of motor spindles for machine tools are illustrated and explained in more detail.

It goes without saying that the actual deviations, especially the actual tilts, which are shown in at least some of the figures, are clearly exaggerated for illustrative purposes. In practice, the deviations are often less than 0.05° (angular degree)-down to less than 0.005°. This is reflected by the wedge thicknesses and gradations of the adjustment discs. By way of example, an adjustment disc has a wedge thickness of 10 μm, 20 μm, or 50 μm (micrometer), based on a diameter of 250 mm (millimeter). It is thus clear that the shape deviations shown are greatly exaggerated for illustrative purposes.

FIG. 3 and FIG. 4 illustrate the mounting/attachment of a motor spindle 40 to a spindle housing 38 of a spindle unit 36, with reference to partial representations. The motor spindle 40 and the spindle housing 38 form a component of the spindle unit 36. The motor spindle 40 is at least partially accommodated in the spindle housing 38. For this purpose, the spindle housing 38 is provided with a mounting surface 110, which is exemplarily arranged as a frontal surface. The motor spindle 40 comprises a spindle body 114. In addition, the motor spindle 40 comprises a longitudinal axis of 116.

Regularly, the motor spindle 40 is aligned with the goal of deliberately aligning this longitudinal axis 116 at right angles to a workpiece support and/or parallel to another axis. Further, a shoulder is formed on the spindle body 114, on which a bearing surface 118 is formed. The bearing surface 118 is arranged as a frontal face. In the exemplary embodiment illustrated in FIGS. 3 and 4, the bearing surface 118 and the support surface 110 point in the same direction. Accordingly, there is no direct contact between the bearing surface 118 and the support surface 110 when the motor spindle 40 is attached to the spindle housing 38. Instead, an indirect attachment is used in this exemplary embodiment.

The bearing surface 118 defines a Z position of the motor spindle 40. The bearing surface 118 is adjacent to a fitting surface that has a fitting diameter 120. The fitting diameter 120 defines a concentric alignment (e.g. in an X-Y plane) of the motor spindle 40. A tuning ring 124 is provided in the exemplary embodiment for mounting the motor spindle 40. The tuning ring 124 can be deliberately selected to change the Z position of the motor spindle 40 in relation to the spindle housing 38.

Further, an adjustment disc 128 is provided for mounting the motor spindle 40. In the exemplary embodiment illustrated in FIGS. 3 and 4, the tuning ring 124 and the adjustment disc 128 are concentrically arranged and aligned. Accordingly, by way of example, the adjustment disc 128 forms an outer ring, while the tuning ring 124 forms an inner ring. An opposite allocation is basically also conceivable.

The adjustment disc 128 comprises frontal faces 130, 132. The frontal face 130 faces the spindle housing 38. The frontal face 132 faces away from the spindle housing 38. Furthermore, the adjustment disc 128 comprises a pitch 134 over its circumference in the form of a defined number of holes/recesses. In this way, a defined rotation orientation of the adjustment disc 128 with respect to the spindle housing 38 can be achieved.

In the exemplary embodiment, the adjustment disc 128 contacts the mounting surface 110 of the spindle housing 38. Further, the adjustment disc 128 contacts a mounting plate 142. In the exemplary embodiment, also the mounting plate 142 is arranged as a ring. The mounting plate 142 may also be referred to as a motor plate. The mounting plate 142 has a frontal face 144 and a frontal face 146. When mounted, the frontal face 144 faces the mounting surface 110 of the spindle housing 38 and/or the bearing surface 118 of the motor spindle 40. The frontal face 146 faces away from this. Furthermore, the motor spindle 40 comprises a fitting seat 150 on its inside diameter, which is adapted to the fit diameter 120 of the spindle body 114. Accordingly, the mounting plate 142 can be mounted on the spindle body 114.

The mounting plate 142 further comprises recesses 154, 156 for mounting and connecting spindle housing 38, motor spindle 40, adjustment disc 128, tuning ring 124 and mounting plate 142. Recesses 154 are assigned to the adjustment disc 128, where corresponding counter elements (pitch 134) are provided. Recesses 156 are assigned to the tuning ring 124, where corresponding counter elements are provided. Fastening elements (screws, bolts, pins) are not shown in FIG. 3 and FIG. 4.

In the mounted state, the adjustment disc 128 contacts the mounting plate 142 with its frontal face 132. The adjustment disc 128 contacts the mounting surface 110 of the spindle housing 38 with its frontal face 130. Furthermore, in the mounted state, the tuning ring 124 is provided between the bearing surface 118 of the spindle body 114 and the frontal face 144 of the mounting plate 142. In case no adjustability in the Z direction is desired, the tuning ring 124 may be dispensed with. In such a state, the frontal face 144 of the mounting plate 142 may directly contact the bearing surface 118.

It is also possible to form the mounting plate 142 integrally with the spindle body 114. In such a case, embodiments are conceivable in which the adjustment disc 128 is arranged directly between the motor spindle 40 and the spindle housing 38. Accordingly, in such a case the bearing surface 118 would face the support surface 110.

FIG. 4 illustrates a (not completely) assembled state of the spindle unit 36. The wedge shape of the adjustment disc 128 is illustrated in cross-section by edge thicknesses h1, h2. Furthermore, the “gap” Δh illustrates the wedge thickness. The following applies: Δh=h1−h2. Hence, when the mounting plate 142 and therefore the adjustment disc 128 are firmly connected to the spindle housing 38, a tilting would occur between the motor spindle 40 (and/or its longitudinal axis 116) and the spindle housing 38. This tilting is now used to align the motor spindle 40 in the desired fashion, in case of position deviations.

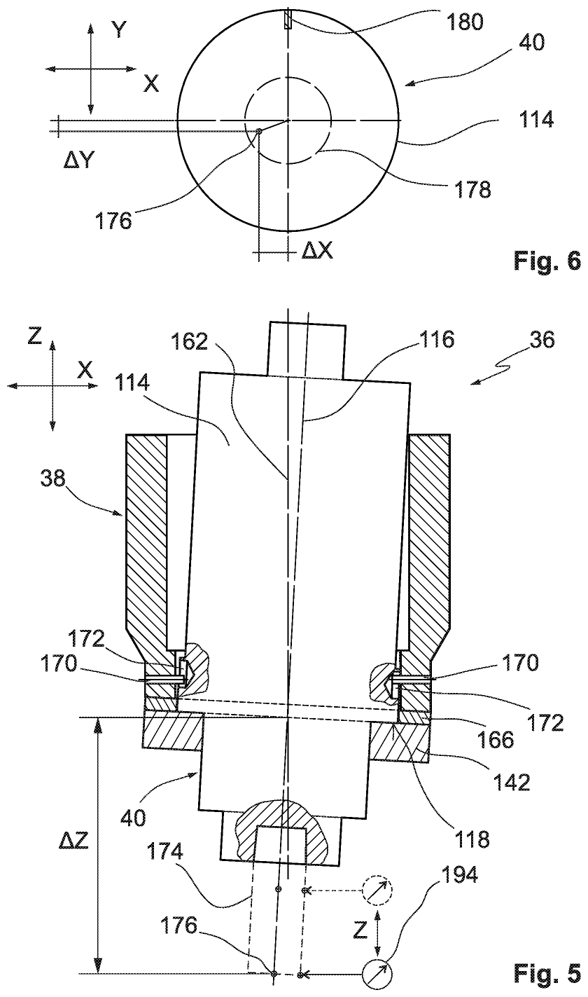

Such an alignment procedure is illustrated with reference to the schematic, simplified representations of FIGS. 5-9. FIG. 5 elucidates a partial cross-sectional side view of a spindle unit 36, which comprises a motor spindle 40 and which is mounted to a spindle housing 38. Due to manufacturing errors, assembly errors and/or other error influences, the spindle 40 with its longitudinal axis 116 is tilted with respect to a nominal alignment (longitudinal axis 162, which illustrates an ideal alignment). The ideal longitudinal axis 162 may, for example, describe the longitudinal direction of a Z guide for the motor spindle 40 or for a workpiece support. In this respect, this ideal longitudinal axis 162 can provide the reference for the alignment of the motor spindle 40.

In FIG. 5 the motor spindle 40 is coupled via a mounting plate 142 with the interposition of a parallel ring 166 (plane-parallel ring) to a frontal face of the spindle housing 38. It is proposed to replace the parallel ring 166 by a suitable adjustment disc, which is to be mounted in a suitable rotation orientation. In this way, tilting can be counteracted so that the longitudinal axis 116 of the motor spindle 40 coincides as completely as possible with the nominal longitudinal axis 162 (e.g. longitudinal direction of a Z guide).

FIG. 5 also illustrates a position securing unit for the motor spindle 40 at the spindle housing 38. This is achieved, for example, by position securing elements 170, which engage in recesses 172. By way of example, the recesses 172 are provided on the spindle body 114. Accordingly, the position securing elements 170 are accommodated at the spindle housing 38. However, this type of position securing does not primarily serve to align the motor spindle with respect to the spindle housing.

To select a suitable adjustment disc, it is first necessary to detect the actual deviation (actual deviation). This can be achieved, for example, by determining the position of a reference point 176. For this purpose, it is conceivable to mount a measuring mandrel 174 or a similar aid on the tool holder of the motor spindle 40, and to detect, in a defined Z position (AZ), position deviations of a reference point 176 (on the circumference of the measuring mandrel 174) with suitable measuring instruments 194 during the relative movement of the motor spindle 40 to the measuring device. In FIG. 5 and FIG. 8, a relative movement between the measuring mandrel 174 and the measuring instrument 194 in the Z-direction is indicated.

This may involve, for example, a measurement in X and Y, wherein the spindle 40 is respectively moved relative to the measuring device (in the Z direction) to detect the total error. Then, a deviation of the reference point 176 in the X-direction (ΔX) and the Y-direction (ΔY) can be determined for the position AZ, confer FIG. 6.

The measurement is based on the goal of detecting a vector of tilting and/or position deviation. In certain embodiments, the position deviation can be described by few and easily understandable values, such as deviations in the X-direction (ΔX) and the Y-direction (ΔY). Provided that it is defined and known in which Z-position (ΔY) the reference point is measured, this information is sufficient.

FIG. 6 illustrates in this connection the projected partial deviations in X and Y. The scale of the representation in FIG. 6 deviates from the scale of the representation in FIG. 5. In FIG. 6, there is also indicated a circle by a line designated by 178, which may also be referred to as a tolerance circle. The tolerance circle 178 is, so to say, the error that a certain adjustment disc having an appropriate rotation orientation may compensate for. Ideally, the adjustment disc is selected so that the actual error of the reference point 176 (actual error) is on or close to the tolerance circle 178. Furthermore, a marker/indicator for the rotation position is indicated in FIG. 6 by 180. The indicator 180 is important for the correct rotation orientation of the selected adjustment disc. If, for example, the adjustment disc was rotated by 180°, i.e. mounted exactly the wrong way round, the error, as the case may be, could even double.

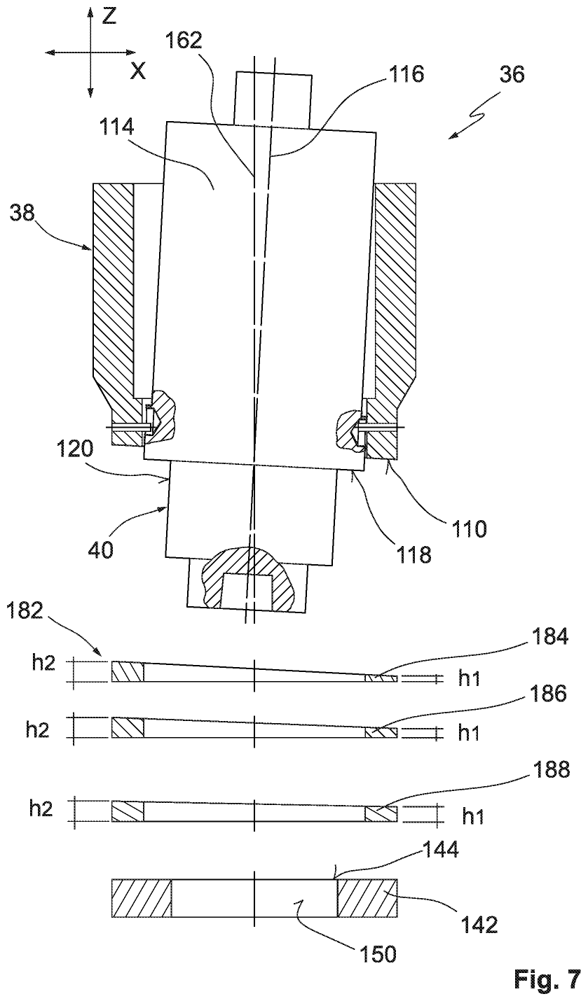

FIG. 7 illustrates the state according to FIG. 5, wherein the mounting plate 142 and also the parallel ring 166 are detached from the motor spindle 40 and/or from the spindle housing 38. Having knowledge of the actual error of the reference point 176, a suitable instance can now be selected from a set 182 of adjustment discs 184, 186, 188 to compensate for the actual error.

The adjustment discs 184, 186, 188 of set 182 are graduated and provided with different wedge thicknesses (Δh=h2−h1). The respectively selected adjustment disc can then be mounted between the mounting surface 110 of the spindle housing 38 and the mounting plate 142. In addition, the 142 mounting plate may contact the bearing surface 118 of the spindle body 114 with its frontal face 144, in addition to the selected adjustment disc in the version shown in FIGS. 5-9. In addition, the mounting plate 142 is located via its fitting seat 150 on the fit diameter 120 of the spindle body 114.

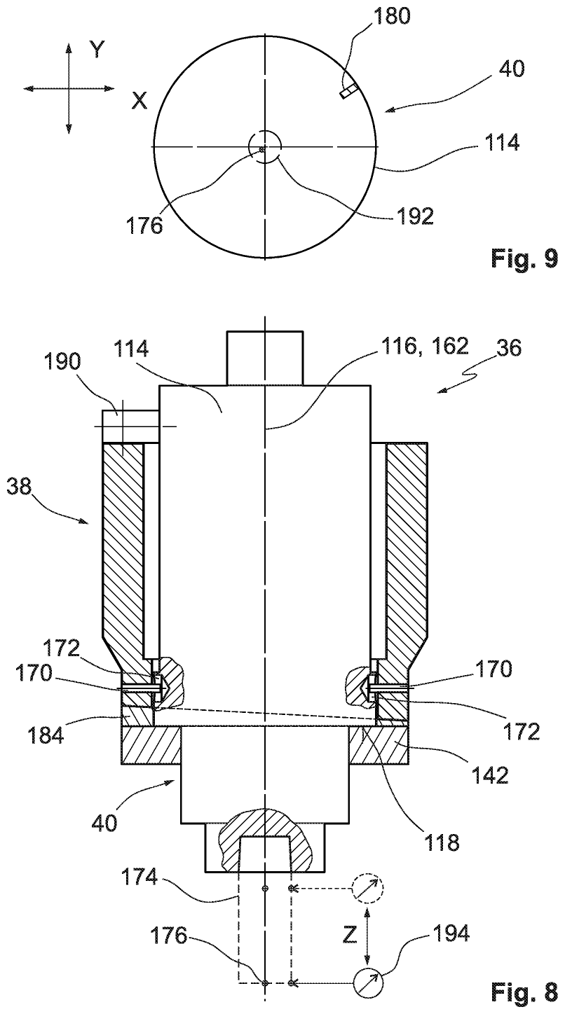

A state after the selection of an adjustment disc 184 and the mounting of the adjustment disc 184 between the spindle housing 38 and the mounting plate 142 for mounting the spindle 40 to the spindle housing 38 is illustrated in FIGS. 8 and 9. The adjustment disc 184 was mounted in a suitable rotation orientation so that the desired nominal position for the longitudinal axis 116 of the motor spindle 40 is achieved. The longitudinal axis 116 coincides with the (ideal) longitudinal axis 162, wherein minimal residual deviations can be present.

The reference point 176 is now just as close to or even on the ideal longitudinal axis 162. Consequently, the tilting error (for example between the longitudinal axis 116 of the motor spindle and a longitudinal direction of the Z guide) has been significantly reduced. FIG. 9 shows, in comparison with FIG. 6, that with a suitable selection and orientation of the adjustment disc 184, the motor spindle 40 and/or its spindle body 114 can be aligned in such a way that the reference point 176 is now close to the center. The quite large tolerance circle 178 in FIG. 6 has been transformed into a considerably smaller (acceptable) tolerance circle 192 in FIG. 9, due on the mounting of the adjustment disc 184. A significant improvement of the positioning accuracy could be achieved. In FIG. 9 and FIG. 6, adjustment discs and/or parallel rings are not shown separately, for illustrative purposes. FIG. 9 further illustrates that the adjustment disc 184 has been mounted in a certain rotation position (confer indicator 180), i.e. opposite to and/or diametrically with respect to the direction of reference point 176 (actual error). In this way, the adjustment disc 184 can counteract the error.

In addition, FIG. 8 illustrates, by means of an element designated by 190, a radial prevention device 190 for the motor spindle 40 and/or its spindle body 114 at and/or in the spindle housing 38. The radial prevention device 190 stiffens the spindle in its nominal position and nominal orientation. In certain embodiments, the radial prevention device 190 is considerably spaced away from the end of the motor spindle 40 on the side of the table. In this region, the motor spindle 40 is already fixed to the spindle housing 38 by the mounting plate 142 and the adjustment disc 184.

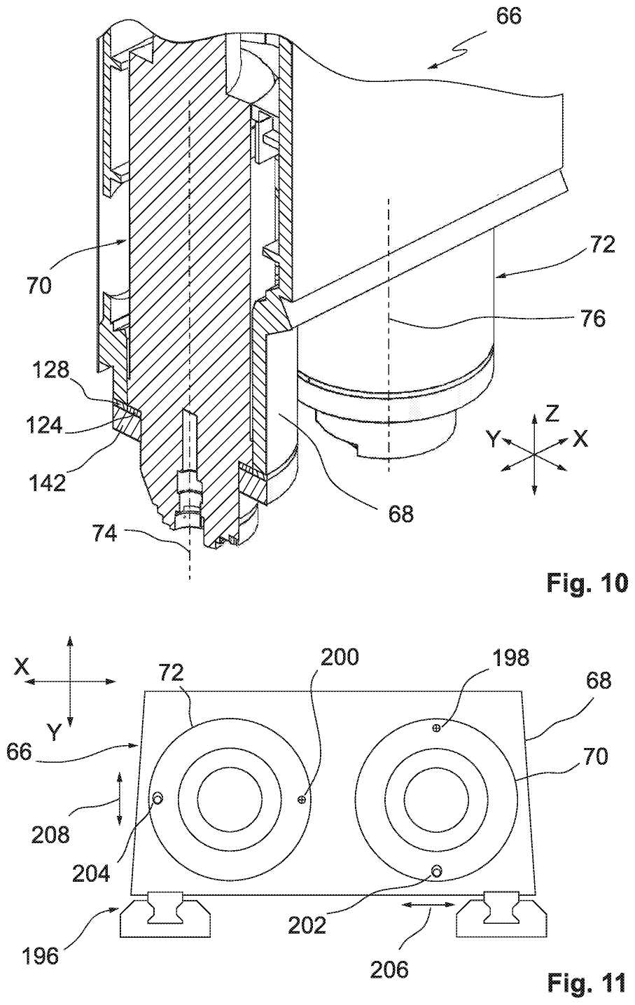

FIG. 10 illustrates a perspective partially cross-sectional partial representation of a spindle unit 66, which is arranged as a double spindle (see also FIG. 2). The spindle unit 66 comprises a spindle housing 68, which provides receptacles for two motor spindles 70, 72, which can be rotated around their longitudinal axes 74, 76, respectively. A design goal for the alignment of the longitudinal axes 74, 76 is, on the one hand, the perpendicularity to a workpiece support and/or a table. However, parallelism between the two longitudinal axes 74 and 76 may also be a design goal. However, parallelism between each of the two longitudinal axes 74, 76 and the Z-direction—i.e. a traversing axis for the Z-direction—may also be a design goal.

The spindle 70 is also mounted via a mounting plate 142 at the spindle housing 68. Between mounting plate 142, spindle housing 68 and a contact surface of spindle 70, an adjustment disc 128 is arranged in the manner already described herein before, and, optionally (at least in exemplary embodiments), also a tuning ring 124. The other spindle 72 is mounted in a similar way to the spindle housing 68.

In addition, reference is made to FIG. 11, which is a simplified schematic front view of a spindle unit 66 having a double spindle (motor spindles 70, 72), see also FIG. 2 and FIG. 10. The spindles 70, 72 are mounted on a spindle housing 68. The spindle unit 66 is movably mounted via its spindle housing 68 on a Z-guide 196.

FIG. 11 elucidates adjustment options for the X-position and the Y-position of the motor spindles 70, 72. The motor spindle 70 comprises a swivel bearing 198. The motor spindle 72 has a swivel bearing 200. The swivel bearings 198, 200 are each arranged in the circumferential region of the motor spindles 70, 72, and fixedly mounted to the spindle housing 68. Furthermore, an adjusting element 202, 204 is assigned to the respective motor spindle 70, 72. The motor spindle 70 is equipped with an adjusting element 202 which is located opposite the swivel bearing 198. The motor spindle 72 is equipped with an adjusting element 204 which is located opposite the swivel bearing 200.

The arrangement of the swivel bearing 198 and the adjusting element 202 allows minimal swivel movements of the motor spindle 70 around the swivel bearing 198. In this way, small adjustment movements in the X direction are possible, confer the double arrow 206. The arrangement of the swivel bearing 200 and the adjusting element 204 allows minimal swivel movements of the motor spindle 72 around the swivel bearing 200. In this way, small adjustment movements in the Y direction are possible, confer the double arrow 208.

The adjusting elements 202, 204 can be equipped with eccentrics which are arranged in corresponding guides (e.g. slotted holes) in order to be able to induce small adjustment movements during a rotary movement, due to the eccentricity. Having concluded the adjustment, the adjusting elements 202, 204 (or spindle bodies of the motor spindles 70, 72) may be fixed to secure the actual position of the motor spindles 70, 72.

It is to be understood that also an arrangement with a single motor spindle may be similarly provided with at least one adjusting element to allow adjustment movements in at least the X-direction and/or the Y-direction. A synchronous alignment of two motor spindles 70, 72 is of great importance for spindle units 66, which are arranged as a double spindle arrangement. This type of alignment may apply to a defined distance (in X direction) between the two motor spindles 70, 72. Furthermore, a goal of alignment can relate to the positioning of both motor spindles 70, 72 in the same Y-position.

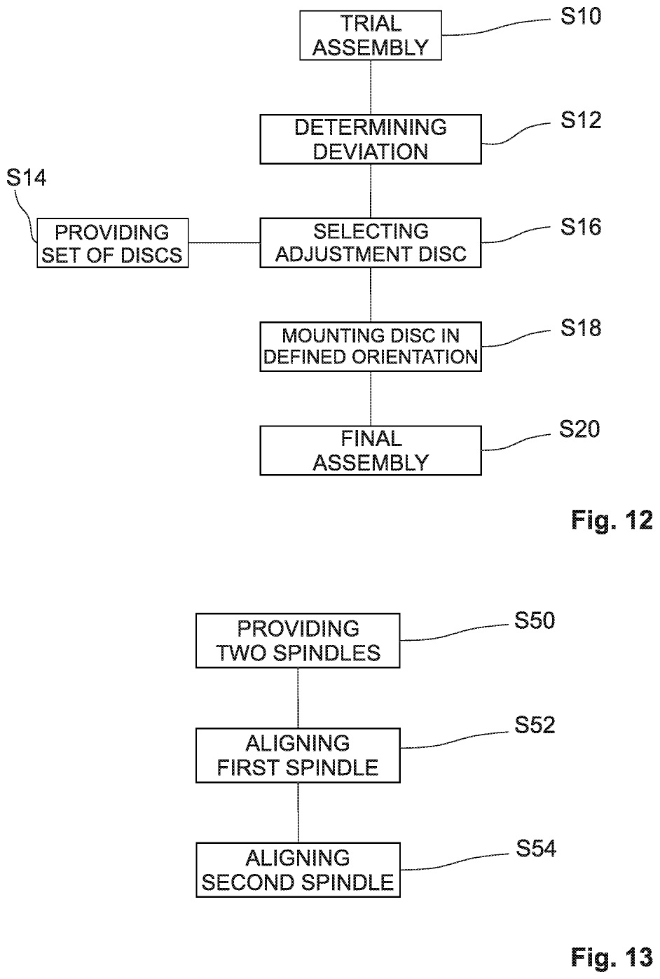

With reference to FIG. 12, a simplified schematic block diagram is used to illustrate and explain in more detail an exemplary embodiment of a method for aligning a motor spindle of a machine tool.

The method comprises a step S10, which involves a pre-assembly or trial mounting of a motor spindle to a spindle housing that is adapted to accommodate the motor spindle. For this purpose, the motor spindle is attached directly or mediately to a mounting surface of the spindle housing, at least temporarily. Pre-assembly may include the interposition of spacers (parallel rings).

This is followed by a step S12, which includes the detection/determination of an actual deviation of the motor spindle. For instance, this involves a determination of a tilting of a longitudinal axis of the motor spindle relative to an ideal nominal position. The nominal position may be a desired perpendicularity with respect to a table for holding workpieces. Furthermore, the nominal position may be a desired parallelism with respect to another longitudinal axis (such as another spindle). Furthermore, the nominal position may be a desired parallelism in relation to a guide of the machine tool, for example in relation to a Z-guide. By way of example, it is conceivable to take up an aid in the form of a measuring mandrel or the like on the motor spindle. The motor spindle is then moved along an axis, such as the Z-axis, relative to the measuring device. The tilting of the spindle can be detected using suitable measuring instruments. In the Z-direction, the measuring point can be distanced from the mounting of the measuring mandrel, so that potential positional errors are more clearly detectable.

It is conceivable to detect deflections of the measuring mandrel in different spatial directions (X-direction, Y-direction). In this way, having knowledge of the Z position, a total deviation can be determined which describes a present vector of the longitudinal axis of the motor spindle (in relation to the nominal position). Ideally, the determination of the actual deviation results in two easily manageable values (for example, deviation of a reference point in the X direction and in the Y direction).

The method involves a further step S14, which includes the provision of a set of adjustment discs. The set includes a plurality of adjustment discs. The adjustment discs have a wedge shape. In certain embodiments, at least some of the adjustment discs of the set differ in their wedge thickness. For example, the wedge thickness of the adjustment discs can be in a range from 5 μm to 100 μm, based on an outer diameter of about 200 mm to 300 mm. A gradation (increment) of the wedge thickness can be at about 5 μm to 20 μm. It goes without saying that adjustment discs with deviating absolute dimensions are also possible, wherein respective wedge angles can be derived on the basis of the above value pairs, which are reflected in correspondingly adapted wedge thicknesses.

In other words, the wedge shape may have a wedge ratio (diameter to wedge thickness) that is approximately in the range of between 2,000:1 and 100,000:1. Alternatively, the wedge shape can have a wedge ratio (diameter to wedge thickness) in the range of about 10,000:1 to 60,000:1. Alternatively, the wedge shape can have a wedge ratio (diameter to wedge thickness) in the range of 20,000:1 to 30,000:1. Alternatively, the wedge shape can have a wedge ratio (diameter to wedge thickness) of about 25,000:1. The wedge shape defined in this way corresponds to a certain wedge angle, which can also be specified by the ratio. By combining several adjustment discs, other ranges may be covered. The gradation/increment between the thicknesses of several adjustment discs may also be in similar ranges.

A step S16 follows, which involves the selection of a suitable adjustment disc from the set of adjustment discs. On the basis of the actual deviation determined in step S12, the most suitable adjustment disc and its rotation position can be easily determined, computationally, on the basis of an algorithm or by means of a diagram. The rotation position is significant so that the wedge-shaped adjustment disc is positioned in a rotation position in which it optimally counteracts the actual deviation.

After selecting the suitable adjustment disc, the same is mounted in a further step S18 in the defined rotation position directly or mediately between the motor spindle and the spindle housing. In this way, the actual deviation can be significantly reduced. By way of example, the adjustment disc can be coupled directly or mediately with a contact surface of the motor spindle and a mounting surface of the spindle housing. The adjustment disc induces a deliberate error that partially compensates for the error that earlier caused the actual deviation.

Step S18 is followed by step S20, which comprises the final assembly of the motor spindle on the spindle housing. This may include a position securing for the motor spindle in order to connect it securely and permanently to the spindle housing in the desired orientation. The step S20 may also include other adjustment or alignment operations, such as alignment of the motor spindle in directions transverse to the longitudinal axis (X-direction and/or Y-direction) and/or an alignment of the motor spindle along the longitudinal axis (Z-direction).

With reference to FIG. 13, a simplified schematic block diagram is used to illustrate and explain in more detail an exemplary embodiment of a method for aligning a machine tool having a double spindle arrangement.

The method comprises a first step S50 involving the provision of a spindle assembly that is configured as a double spindle. Accordingly, the spindle arrangement comprises a spindle housing and/or a headstock in which receptacles for two motor spindles are provided. Step S50 further involves the provision of two motor spindles of that kind. This may involve motor spindles of the same type. However, the motor spindles in can also be arranged differently. Similar motor spindles are typically used for parallel machining to increase the performance of the machine tool. Different motor spindles can be used, for example, if a machine tool is to be provided that is operable to enable different operations (for example, with different speed levels for different tools).

In a further step S52, the first one of the two motor spindles is aligned. Alignment may include an alignment of the longitudinal axis of the motor spindle relative to a table and/or workpiece fixture/support. Preferably, the alignment uses at least some of the steps S10 to S20 of the method illustrated with reference to FIG. 12.

This is followed by another step, S54, which involves aligning the second one of the two motor spindles. Alignment may involve an alignment of the longitudinal axis of the second motor spindle with respect to the longitudinal axis of the first motor spindle. In certain embodiments, the alignment uses at least some of the steps S10 to S20 of the method illustrated with reference to FIG. 12.

What is claimed is:

1. A method for aligning a spindle of a machine tool, the spindle having a longitudinal axis and being rotatable about the longitudinal axis, the method comprising the following steps:
performing a trial mounting of the spindle to a spindle housing, comprising mediately or directly attaching a bearing surface of the spindle to a support surface of the spindle housing,
detecting an actual deviation of the spindle,
selecting a wedge-shaped adjustment disc depending on the detected actual deviation, and
arranging the adjustment disc between the bearing surface of the spindle and the support surface of the spindle housing in a defined rotation orientation so that the adjustment disc at least partially corrects the actual deviation.

2. The method of claim 1, wherein the step of detecting an actual deviation of the spindle comprises detecting an actual tilting of the longitudinal axis of the spindle.

3. The method of claim 1, further comprising the following steps:
providing a set comprising a plurality of adjustment discs having different wedge thicknesses, and
selecting as the adjustment disc for the correction of the actual deviation
an adjustment disc of the set whose wedge thickness at least approximately corresponds to the detected actual deviation, or
two or more adjustment discs of the set whose combined wedge thickness at least approximately corresponds to the detected actual deviation.

4. The method of claim 3, wherein the step of providing a set comprises providing a set comprising at least three adjustment discs having different wedge thicknesses.

5. The method of claim 4, wherein the wedge thicknesses of the adjustment discs of the set are graduated with respect to each other by a value in the range of between 5 μm and 20 μm, in relation to an outer diameter of the adjustment discs.

6. The method of claim 1, wherein the adjustment disc has a wedge thickness, measured at an outer diameter of the adjustment disc in a range of between 5 μm and 100 μm, compared to a plane-parallel disc.

7. The method of claim 1, wherein the adjustment disc has a wedge ratio in the range of 2,000:1 to 100,000:1.

8. The method of claim 1, wherein a plurality of indexed rotation positions for the adjustment disc is provided for the mounting of the adjustment disc between the contact surface of the spindle and the support surface of the spindle housing, and wherein the step of detecting an actual deviation of the spindle also delivers a setting for the rotation position in which the adjustment disc is mounted in the defined rotation orientation.

9. The method of claim 1, wherein the wedge-shaped adjustment disc is mounted in such a way that the error caused by the wedge shape of the adjustment disc counteracts the actual deviation of the spindle.

10. The method of claim 9, wherein the adjustment disc is provided with frontal faces which are minimally inclined with respect to one another, which inclination causes a tilting between the spindle and the spindle housing when the adjustment disc is mounted therebetween in the defined rotary orientation, which tilting counteracts the actual deviation detected in the step of detecting the actual deviation.

11. The method of claim 1, wherein the step of detecting the actual deviation comprises:
detecting a deviation of a reference point in two spatial directions in a plane, which is spaced away from the contact surface of the spindle and the support surface of the spindle housing, and which is oriented perpendicular to the longitudinal axis of the spindle.

12. The method of claim 1, wherein the detection of the actual deviation comprises a detection of an actual angular deviation and a detection of an actual rotation position of the actual angular deviation of the spindle.

13. The method of claim 1, wherein the spindle is arranged to be attached to the spindle housing via a mounting plate, wherein the mounting plate is arranged to be interposed between the support surface of the spindle housing and the bearing surface of the spindle.

14. A method for aligning a double spindle of a machine tool comprising a first spindle and a second spindle that are disposed in a common spindle housing, the method comprising the steps of:
aligning the first spindle in accordance with the method of claim 1, the alignment being performed with respect to a workpiece support or a traversing axis, and aligning the second spindle in accordance with the method of claim 1,
the alignment being performed with respect to the first spindle in order to achieve a desired parallelism between the two spindles.

15. The method of claim 14, further comprising the following step:
alignment of the first spindle and the second spindle in a plane that is perpendicular to the longitudinal axis of at least one of the first spindle and the second spindle,
wherein a first adjusting element is coupled to the first spindle and the spindle housing,
wherein a second adjusting element is coupled to the second spindle and the spindle housing,
wherein the first adjusting element is configured to displace the first spindle relative to the spindle housing in a first direction,
wherein the second adjusting element is configured to displace the second spindle relative to the spindle housing in a second direction, and
wherein the first direction and the second direction are inclined to each other.

16. The method of claim 15, wherein the first adjusting element is a first eccentric, wherein the second adjusting element is a second eccentric, wherein the first eccentric radially engages the first spindle, wherein the second eccentric radially engages the second spindle, and wherein the first direction and the second direction are perpendicular to each other.

17. A use of a set of adjustment discs for aligning a spindle of a machine tool in accordance with the method of claim 1, wherein the set comprises at least three adjustment discs being wedge-shaped and having different wedge thicknesses.

18. A machine tool, comprising:
a workpiece support for holding at least one workpiece, and
a spindle housing that supports at least one tool spindle which is configured as a spindle for receiving at least one tool and which is rotatable about its longitudinal axis,
wherein relative traverse movement can be generated between the workpiece support and the at least one spindle, and
wherein the spindle is coupled to a support surface of the spindle housing via an adjustment disc, which is wedge-shaped and which is arranged between the bearing surface of the spindle and the support surface of the spindle housing in a defined rotation orientation so that a deviation of the spindle with respect to the workpiece support is at least partially compensated.

19. The machine tool of claim 18, wherein the adjustment disc comprises a plurality of indexed rotation positions, and wherein the defined rotation orientation of the adjustment disc corresponds to one of the plurality of indexed rotation positions.

20. The machine tool of claim 18, comprising a first spindle and a second spindle which are accommodated at a common spindle housing and aligned parallel to one another, wherein at least one of the first spindle and the second spindle is coupled to a support surface of the spindle housing via the adjustment disc.
